(19) United States
(12) Patent Application Publication
(10) Pub. No.: US 2014/0220418 A1
(43) Pub. Date: Aug. 7, 2014

(54) BATTERY MODULE

(71) Applicant: HON HAI PRECISION INDUSTRY CO., LTD., New Taipei (TW)

(72) Inventor: JEN-JUNG HSIAO, New Taipei (TW)

(73) Assignee: HON HAI PRECISION INDUSTRY CO., LTD., New Taipei (TW)

(21) Appl. No.: 14/161,666

(22) Filed: Jan. 22, 2014

(30) Foreign Application Priority Data
Feb. 5, 2013 (CN) 2013100452678

(51) Int. Cl. H01M 2/10; H01M 2/20

(52) U.S. Cl. CPC H01M 2/1016; H01M 2/202; H01M 2/1022; H01M 2/1077; H01M 2/204; H01M 2/206
USPC 429/158; 429/156

(57) ABSTRACT

A battery module includes a casing and a plurality of battery cells installed in the casing. The casing includes a sloping side panel. Widths of the casing along a first direction become narrower gradually towards a second direction that is substantially perpendicular to the first direction. The plurality of battery cells is arranged in a plurality of columns. The plurality of columns of battery cells becomes shorter gradually towards the second direction. Each column of battery cells abuts the sloping side panel.

### BACKGROUND

1. Technical Field

The present disclosure relates to a batter module with a plurality of battery cells.

2. Description of Related Art

A battery module includes a casing and a plurality of battery cells disposed in the casing. Each of the plurality of battery cells has the same shape as each other. The casing has a rectangular or square shape. The plurality of battery cells can be arranged in a matrix and installed in the casing. However, there may be some empty space in the casing that is not occupied by the plurality of battery cells, causing a waste of space.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a first embodiment of a battery module.

FIG. 2 is a block diagram of a second embodiment of a battery module.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean “at least one.”

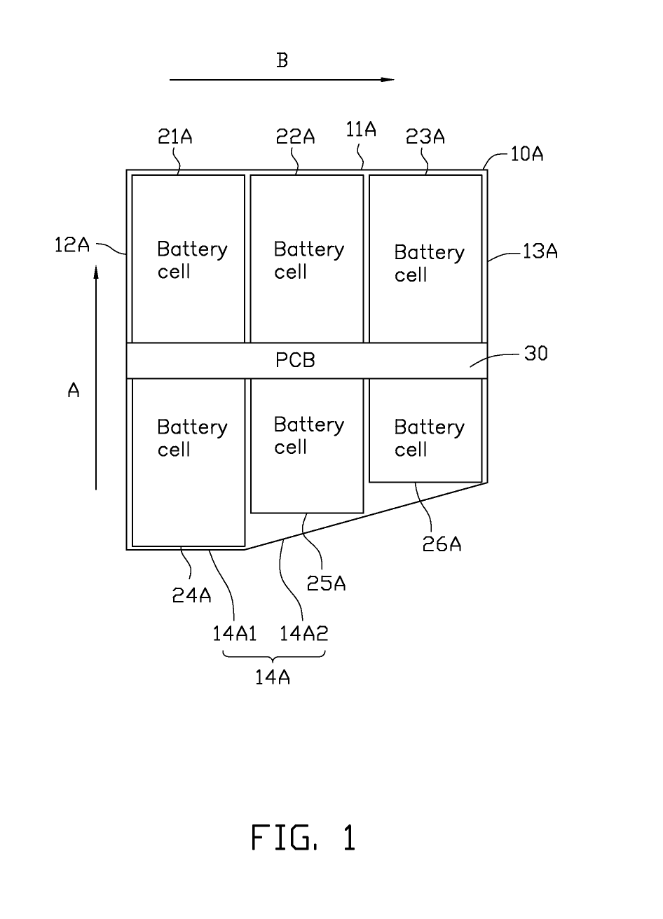

FIG. 1 shows a first embodiment of a battery module which includes a casing 10A and a plurality of battery cells arranged in the casing 10A. The plurality of battery cells includes a first battery cell 21A, a second battery cell 22A, a third battery cell 23A, a fourth battery cell 24A, a fifth battery cell 25A, and a sixth battery cell 26A. A cross section of each of the plurality of battery cells has a rectangular shape.

The casing 10A includes a first side panel 11A, a second side panel 12A, a third side panel 13A, and a fourth side panel 14A. The second side panel 12A and the third side panel 13A are substantially parallel to each other. The first side panel 11A is substantially perpendicularly connected between the second side panel 12A and the third side panel 13A. A length of the second side panel 12A along a first direction A perpendicular to the first side panel 11A is greater than that of the third side panel 13A. The fourth side panel 14A locates between and connects the second side panel 12A and the third side panel 13A. The fourth side panel 14A is spaced away from the first side panel 11A. In this embodiment, each of the first side panel 11A, the second side panel 12A and the third side panel 13A is straight, the forth side panel 14A is bent. The fourth side panel 14A includes a first section 14A1 substantially perpendicularly connecting the second side panel 12A and a second section 14A2 slopingly connecting the first section 14A1 and the third side panel 13A. The third side panel 13A and the second section 14A2 cooperatively define a non-rectangular corner at a joint of the third side panel 13A and the second section 14A2. In this embodiment, the non-rectangular corner is with an obtuse angle. Distances between the first side panel 11A and the second section 14A2 become narrower gradually along a second direction B that is perpendicular to and oriented towards the third side panel 13A.

The first battery cell 21A, the second battery cell 22A and the third battery cell 23A are arranged in a first row in the casing 10A. The battery cells 21A, 22A, 23A in the first row abut an inner side of the first side panel 11A. The fourth battery cell 24A, the fifth battery cell 25A and the sixth battery cell 26A are arranged in a second row in the casing 10A. The battery cells 24A, 25A, 26A in the second row are located adjacent to the fourth side panel 14A. The first battery cell 21A and the fourth battery cell 24A are arranged in a first column and abut the second side panel 12A. The second battery cell 22A and the fifth battery cell 25A are arranged in a second column. The third battery cell 23A and the sixth battery cell 26A are arranged in a third column and abut the third side panel 13A. The second column is located between the first column and the third column. A printed circuit board (PCB) 30 is located between the first row of battery cells 21A, 22A, 23A and the second row of battery cells 24A, 25A, 26A. In one embodiment, the first battery cell 21A, the second battery cell 22A and the third battery cell 23A are connected to each other in parallel. The fourth battery cell 24A, the fifth battery cell 25A and the sixth battery cell 26A are connected to each other in parallel. The first row of battery cells 21A, 22A, 23A and the second row of battery cells 24A, 25A, 26A are connected to each other is series.

In one embodiment, a size of each of the first battery cell 21A, the second battery cell 22A, the third battery cell 23A is the same as each other. A width of the fourth battery cell 24A, the fifth battery cell 25A, and the sixth battery cell 26A is substantially equal to the width of each of the first battery cell 21A, the second battery cell 22A, and the third battery cell 23A. A length of the fifth battery cell 25A is less than that of the fourth battery cell 24A, but greater than that of the six battery 26A. The more the column of battery cells is close to the third side panel 13A, i.e., the more the battery cells are close to the non-rectangular corner, the less the length of the battery cells is.

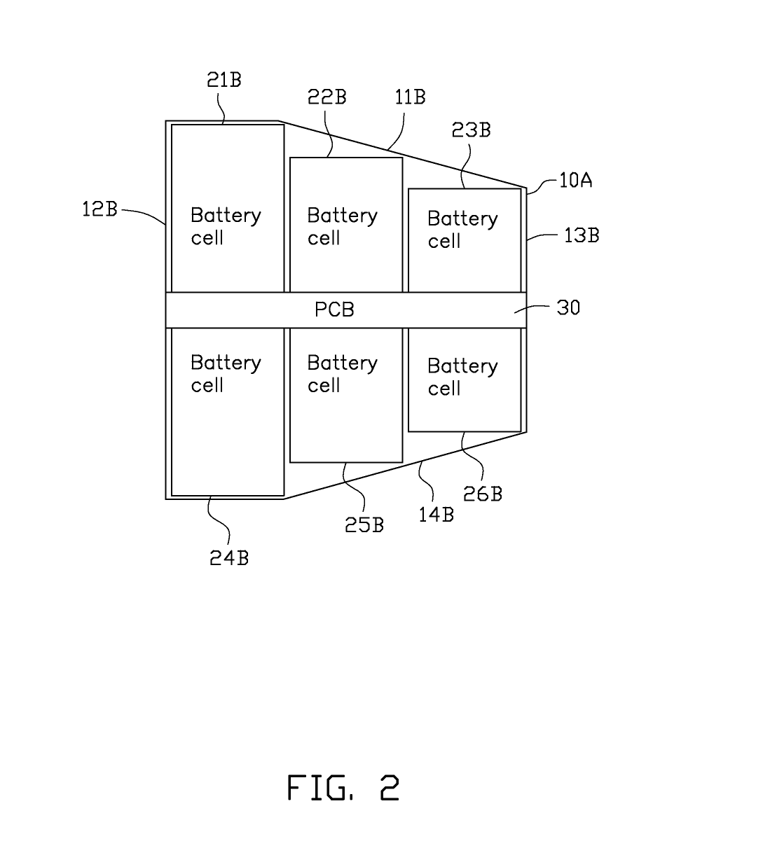

FIG. 2 shows a second embodiment of a battery module which comprises a casing 10B and a plurality of battery cells arranged in the casing 10B. The plurality of battery cells includes a first battery cell 21B, a second battery cell 22B, a third battery cell 23B, a fourth battery cell 24B, a fifth battery cell 25B, and a sixth battery cell 26B.

The casing 10B includes a first side panel 11B, a second side panel 12B, a third side panel 13B, and a fourth side panel 14B. The first side panel 11B and the fourth side panel 14B are symmetrical to each other. The second side panel 12B and the third side panel 13B are substantially parallel to each other. A length of the second side panel 12B is greater than that of the third side panel 13B. In this embodiment, the second side panel 12B and the third side panel 13B each are straight, the first side panel 11B and the forth side panel 14B each are bent. Each of the first side panel 11B and the fourth side panel 14B has a slanting portion connected to the third side panel 13B. The first side panel 11B and the second side panel 12B cooperatively define a first rectangular corner at a joint of the first side panel 11B and the second side panel 12B. The second side panel 12B and the forth side panel 14B cooperatively define a second rectangular corner at a joint of the second side panel 12B and the forth side panel 14B. The first side panel 11B and the third side panel 13B cooperatively define a first non-rectangular corner at a joint of the first side panel 11B and the third side panel 13B. The forth side panel 14B and the third side panel 13B cooperatively define a second non-rectangular corner at a joint of the forth side panel 14B and the third side panel 13B. The more the battery cells are close to the third side panel 13B, i.e., the more the battery cells are close to the first and second non-rectangular corners, the shorter the battery cells are.

The first battery cell 21B, the second battery cell 22B, and the third battery cell 23B are arranged in a first row. The first row of battery cells (21B, 22B, 23B) abuts an inner side of the first side panel 11B. The fourth battery cell 24B, the fifth battery cell 25B, and the sixth battery cell 26B are arranged in a second row. The second row of battery cells (24B, 25B, 26B) is located adjacent to the fourth side panel 14B. The first battery cell 21B and the fourth battery cell 24B are arranged in a first column and abut the second side panel 12B. The second battery cell 22B and the fifth battery cell 25B are arranged in a second column. The third battery cell 23B and the sixth battery cell 26B are arranged in a third column and abut the third side panel 13B. The second column is located adjacent to and between the first column and the third column. In one embodiment, the battery cells in each column have the same size and capacity as each other. The columns of battery cells become shorter along a direction that is substantially perpendicular to and oriented towards the third side panel 13B.

In the above embodiments, the battery cells become shorter as the width of the casing 10A or 10B becomes narrower. Each of the battery cells abuts an inner wall of the casing 10A or 10B and occupies the inner space of the casing 10A or 10B as much as possible, which is benefit to improve a space utilization ratio and improve a capacity of the battery module.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A battery module comprising:
a casing comprising a sloping side panel, widths of the casing along a first direction becoming narrower gradually towards a second direction that is substantially perpendicular to the first direction; and
a plurality of battery cells received in the casing and arranged in a plurality of columns; the plurality of columns of battery cells becomes shorter gradually towards the second direction; and at least one battery cell in each column abutting the sloping side panel.

2. The battery module of claim 1, wherein the plurality of battery cells is arranged in at least two rows, the battery cells in each row is aligned along the second direction, and a printed circuit board is located between and abuts the at least two rows of battery cells for electrically connecting the battery cells to each other.

3. The battery module of claim 2, wherein the plurality of battery cells is arranged in a first row and a second row, and the first row of battery cells and the second row of battery cells are connected in series.

4. The battery module of claim 3, wherein the first row of battery cells comprises a first battery cell, a second battery cell, and a third battery cell which are connected in parallel, and the second row of battery cells comprises a fourth battery cell, a fifth battery cell, and a sixth battery cell which are connected in parallel.

5. The battery module of claim 4, wherein the first battery cell and the fourth battery cell are arranged in a first column along the first direction, the second battery cell and the fifth battery cell are arranged in a second column along the first direction, and the third battery cell and the sixth battery cell are arranged in a third column along the first direction; the second row of battery cells is shorter than the first row of battery cells, and the third row of battery cells is shorter than the second row of battery cells.

6. The battery module of claim 5, wherein a size and capacity of each of the first battery cell, the second battery cell, the third battery cell is the same as each other, a width of each of the fourth battery cell, the fifth battery cell, and the sixth battery cell is the same as the width of each of the first battery cell, the second battery cell, and the fifth battery cell, and a height of the fifth battery cell is less than that of the fourth battery cell, but greater than that of the sixth battery cell.

7. The battery module of claim 5, wherein a size and capacity of each of the first battery cell and the fourth battery cell is the same as each other, a size and capacity of each of the second battery cell and the fifth battery cell is the same as each other, and a size and capacity of the third battery cell and the sixth battery cell is the same as each other.

8. The battery module of claim 5, wherein a cross section of each of the plurality of battery cells has a rectangular shape.

9. The battery module of claim 8, wherein the casing further comprising a first side panel, a second side panel and a third side panel that is substantially parallel to and shorter than the second side panel, the first side panel and the sloping side panel are connected between the second side panel and the third side panel.

10. The battery module of claim 9, wherein the first row of battery cells abuts the first side panel, the second row of battery cells abuts the sloping side panel, the first row of battery cells abuts the second side panel, and the third row of battery cells abuts the third side panel.

11. A battery module comprising:
a casing comprising a plurality of side panels, the plurality of side panels comprising at least one sloping side panel, widths of the casing along a first direction becoming narrower gradually towards a second direction that is substantially perpendicular to the first direction; and
a plurality of battery cells installed in the casing and arranged in a plurality of columns and rows; the plurality of columns of battery cells becomes shorter gradually towards the second direction; and at least one battery cell in each column abutting the sloping side panel.

12. The battery module of claim 11, wherein the plurality of battery cells is arranged in at least two rows, the battery cells in each row is aligned along the second direction, and a printed circuit board is located between and abuts the at least two rows of battery cells for electrically connecting the battery cells to each other.

13. The battery module of claim 12, wherein the plurality of battery cells is arranged in a first row and a second row, and the first row of battery cells and the second row of battery cells are connected in series.

14. The battery module of claim 13, wherein the first row of battery cells comprises a first battery cell, a second battery cell, and a third battery cell which are connected in parallel, and the second row of battery cells comprises a fourth battery cell, a fifth battery cell, and a sixth battery cell which are connected in parallel.

15. The battery module of claim 14, wherein the first battery cell and the fourth battery cell are arranged in a first column along the first direction, the second battery cell and the fifth battery cell are arranged in a second column along the first direction, and the third battery cell and the sixth battery cell are arranged in a third column along the first direction; the second row of battery cells is shorter than the first row of battery cells, and the third row of battery cells is shorter than the second row of battery cells.

16. The battery module of claim 15, wherein a size and capacity of each of the first battery cell, the second battery cell, the third battery cell is the same as each other, a width of each of the fourth battery cell, the fifth battery cell, and the sixth battery cell is the same as the width of each of the first battery cell, the second battery cell, and the fifth battery cell, and a height of the fifth battery cell is less than that of the fourth battery cell, but greater than that of the sixth battery cell.

17. The battery module of claim 15, wherein a size and capacity of each of the first battery cell and the fourth battery cell is the same as each other, a size and capacity of each of the second battery cell and the fifth battery cell is the same as each other, and a size and capacity of the third battery cell and the sixth battery cell is the same as each other.

18. The battery module of claim 15, wherein the casing further comprising a first side panel, a second side panel and a third side panel that is substantially parallel to and shorter than the second side panel, the first side panel and the sloping side panel are connected between the second side panel and the third side panel, and each column of battery cells is located between and abutted the first side panel and the sloping side panel.

19. The battery module of claim 18, wherein the first row of battery cells abuts the second side panel, and the third row of battery cells abuts the third side panel.

20. A battery module comprising:
a casing comprising a plurality of side panels, the side panels defining a non-rectangular corner at a joint of the side panels; and
a plurality of battery cells received in the casing, wherein the more the battery cells are close to the non-rectangular corner, the shorter the battery cells are.
